(19) United States
(12) Patent Application Publication
(10) Pub. No.: US 2025/0018501 A1
(43) Pub. Date: Jan. 16, 2025

(54) METHOD AND DEVICE FOR ADJUSTING OPTICAL AXIS OF LASER LIGHT

(71) Applicant: Tokyo Seimitsu Co., Ltd., Tokyo (JP)

(72) Inventors: Chikara AIKAWA, Tokyo (JP); Takashi MORIMOTO, Tokyo (JP); Hirokazu HAYASHI, Tokyo (JP)

(73) Assignee: Tokyo Seimitsu Co., Ltd., Tokyo (JP)

(21) Appl. No.: 18/898,920

(22) Filed: Sep. 27, 2024

Related U.S. Application Data
(63) Continuation of application No. PCT/JP2023/010046, filed on Mar. 15, 2023.

(30) Foreign Application Priority Data
Mar. 28, 2022 (JP) 2022-052255
Nov. 30, 2022 (JP) 2022-191842
Nov. 30, 2022 (JP) 2022-191843

(51) Int. Cl. B23K 26/04; B23K 26/03; B23K 26/06; B23K 26/073

(52) U.S. Cl. CPC B23K 26/043; B23K 26/03; B23K 26/0643; B23K 26/073

(57) ABSTRACT

Provided are a method and a device for adjusting an optical axis of laser light, capable of accurately grasping change in the state of the laser light and maintaining the quality of laser processing. The method for adjusting an optical axis of laser light includes: a step of detecting a position of laser light by position sensitive detectors arranged at two or more detection positions on an optical path of the laser light that is output from a laser light source toward a workpiece; and a step of adjusting, based on the detected position of the laser light, at least one of a position and an angle of optical elements arranged at two or more positions on the optical path of the laser light, to adjust an optical axis of the laser light.

### CROSS-REFERENCE TO RELATED APPLICATIONS

The present application is a Continuation of PCT International Application No. PCT/JP2023/010046 filed on Mar. 15, 2023 claiming priorities under 35 U.S.C. § 119 (a) to Japanese Patent Application No. 2022-052255 filed on Mar. 28, 2022, Japanese Patent Application No. 2022-191842 filed on Nov. 30, 2022, and Japanese Patent Application No. 2022-191843 filed on Nov. 30, 2022. Each of the above applications is hereby expressly incorporated by reference, in its entirety, into the present application.

### BACKGROUND OF THE INVENTION

### Field of the Invention

The present invention relates to a method and a device for adjusting an optical axis of laser light and particularly relates to a technique for adjusting the optical axis of laser light in a laser processing apparatus.

### Description of the Related Art

There is known a laser processing apparatus (also referred to as a laser dicing apparatus) that irradiates a workpiece, such as a semiconductor wafer, with laser light to form a processing groove or form laser-modified regions (laser processing regions) that serves as a starting point of cutting, inside the workpiece. The semiconductor wafer after the laser-processing is segmented (diced) into individual chips at scheduled dividing lines by a cleaving process such as expanding or braking.

When the state of laser light in the laser processing apparatus changes from the state at the completion of adjustment, a beam profile of the laser light at a processing point may change so that the result of processing of the workpiece may change due to the influence of the change in the beam profile. Patent Literatures 1 and 2 disclose techniques for detecting such changes in the state of the laser light.

Patent Literature 1 discloses a method of detecting a position of laser beam at a processing point after passing through a condenser lens and adjusting an optical axis of the laser beam.

Patent Literature 2 discloses a system that detects a position of a reflection spot of laser light in a laser gain medium that emits fluorescent light when absorbing part of excitation light, and controls the angle or position of an optical element to adjust an optical axis of the laser light.

### CITATION LIST

### Patent Literatures

Patent Literature 1: Japanese Patent Application Laid-Open No. 2020-189323
Patent Literature 2: Japanese Patent Application Laid-Open No. 2017-022351

### SUMMARY OF THE INVENTION

The techniques disclosed in Patent Literatures 1 and 2 detect a beam position at the processing point that is irradiated with laser light, which makes it difficult to accurately grasp change in the state of the laser light as described below.

As shown in FIG. 17, in a case of detecting laser light which has passed through an optical element OE (for example, a condenser lens, etc.) at one detection position OP, there are countless optical axes passing through the detection position OP. These countless optical axes passing through the one detection position OP are different from each other in the incident position and incident angle on the optical element OE. These optical axes are also inclined with respect to lines parallel to an optical axis of the optical element OE (solid lines in FIG. 17, which are perpendicular lines when the optical element OE is rectangular).

Therefore, it is not possible to accurately detect the incident position and incident angle of the laser light incident on the optical element only by detecting the beam position at the processing point as in Patent Literatures 1 and 2. Further, the techniques disclosed in Patent Literatures 1 and 2 cannot accurately detect deviation of the reflection angle of a mirror, which serves as the optical element, from a design value.

Further, the technique disclosed in Patent Literature 1 is intended to reduce man-hours required for the adjustment of the optical axis of the laser beam. The technique disclosed in Patent Literature 2 is intended to omit the light source of a reference laser used for adjusting a laser optical axis. In other words, because no consideration is given to monitoring of an optical axis deviation of the laser light to maintain the beam profile in both the techniques disclosed in Patent Literatures 1 and 2, it is difficult to maintain the quality of laser processing.

The present invention has been made in view of such circumstances, and aims to provide a method and a device for adjusting an optical axis of laser light, capable of accurately grasping change in the state of the laser light and maintaining the quality of laser processing.

In order to accomplish the above object, a method for adjusting an optical axis of laser light according to a first aspect of the present invention includes: a step of detecting a position of laser light by position sensitive detectors arranged at two or more detection positions on an optical path of the laser light output from a laser light source toward a workpiece; and a step of adjusting, based on the position of the laser light, at least one of a position and an angle of at least two optical elements on the optical path of the laser light, to adjust the optical axis of the laser light.

According to a second aspect of the present invention, in the method for adjusting an optical axis of laser light according to the first aspect, the detection positions are provided at positions other than a processing point to be irradiated with the laser light on the workpiece.

According to a third aspect of the present invention, in the method for adjusting an optical axis of laser light according to the first or second aspect, when a difference between the position of the laser light detected by the position sensitive detectors arranged at two or more detection positions and a preset reference value is equal to or more than a threshold value, adjustment of the optical axis of the laser light is performed.

According to a fourth aspect of the present invention, the method for adjusting an optical axis of laser light according to any of the first to third aspects, includes a step of adjusting the optical axis by a beam expander arranged retractably on the optical path of the laser light.

According to a fifth aspect of the present invention, in the method for adjusting an optical axis of laser light according to the fourth aspect, the position of the laser light in a state where magnification of the beam expander is set to 1× is adjusted in accordance with the position of the laser light in a state where the beam expander is retracted from the optical path of the laser light.

A device for adjusting an optical axis of laser light according to a sixth aspect of the present invention includes: position sensitive detectors arranged at two or more detection positions on an optical path of laser light output from a laser light source toward a workpiece; and an adjustment mechanism configured to adjust, based on a position of the laser light detected by the position sensitive detectors, at least one of a position and an angle of optical elements at two or more positions on the optical path of the laser light, to adjust the optical axis of the laser light.

A method for adjusting an optical axis of laser light according to a seventh aspect of the present invention includes: a step of detecting a position of laser light output from a laser light source toward a workpiece, by using a pair of position sensitive detectors respectively arranged at positions after the laser light has passed through a pair of half mirrors, the pair of half mirrors fixed on an upstream side and a downstream side of a beam expander; and a step of adjusting, based on the position of the laser light, at least one of a position and an angle of a pair of movable mirrors arranged closer to the laser light source than the pair of half mirrors on an optical path of the laser light, to adjust an optical axis of the laser light.

According to an eighth aspect of the present invention, in the method for adjusting an optical axis of laser light according to the seventh aspect, the pair of position sensitive detectors is provided at a position other than a processing point to be irradiated with the laser light, on the workpiece.

According to a ninth aspect of the present invention, in the method for adjusting an optical axis of laser light according to the seventh or eighth aspect, when a difference between the position of the laser light detected by the pair of position sensitive detectors and a preset reference value is equal to or more than a threshold value, adjustment of the optical axis of the laser light is performed.

According to a tenth aspect of the present invention, in the method for adjusting an optical axis of laser light according to the ninth aspect, adjusting at least one of the position and the angle of one of the pair of movable mirrors and setting the position of the laser light detected by one of the pair of position sensitive detectors as a reference value, are repeated for each of the movable mirrors to converge the position of the laser light detected by each position sensitive detector with the respective reference position.

A device for adjusting an optical axis of laser light according to an eleventh aspect of the present invention includes: a pair of position sensitive detectors respectively arranged at positions after the laser light has passed through a pair of half mirrors, the half mirrors respectively fixed on an upstream side and a downstream side of a beam expander; and an adjustment mechanism configured to adjust, based on the position of the laser light detected by each of the position sensitive detectors, at least one of a position and an angle of a pair of movable mirrors that is arranged closer to a laser light source than the pair of half mirrors on an optical path of the laser light, to adjust an optical axis of the laser light.

A method for adjusting an optical axis of laser light according to a twelfth aspect of the present invention includes: a step of detecting a position of laser light output from a laser light source toward a workpiece, by using position sensitive detectors respectively arranged on an upstream side and a downstream side of a beam expander; and a step of moving the beam expander to adjust an optical axis of the laser light based on the position of the laser light detected by the position sensitive detectors in a state where the beam expander is arranged on an optical path of the laser light and the position of the laser light detected by the position sensitive detectors in a state where the beam expander is retracted from the optical path of the laser light.

According to a thirteenth aspect of the present invention, in the method for adjusting an optical axis of laser light according to the twelfth aspect, in adjusting the optical axis, the position of the laser light in a state where magnification of the beam expander is set to 1× is adjusted in accordance with the position of the laser light in the state where the beam expander is retracted from the optical path of the laser light.

According to a fourteen aspect of the present invention, in the method for adjusting an optical axis of laser light according to the twelfth or thirteenth aspect, in adjusting the optical axis, the position of the laser light in a state where magnification of the beam expander is set to other than 1× is adjusted in accordance with the position of the laser light in the state where the beam expander is retracted from the optical path of the laser light.

According to a fifteenth aspect of the present invention, the method for adjusting an optical axis of laser light according to any of the twelfth to thirteenth aspects, includes a step of performing quality determination for the beam expander based on change in the position of the laser light detected by the position sensitive detectors when the magnification of the beam expander is changed.

According to a sixteenth aspect of the present invention, in the method for adjusting an optical axis of laser light according to the fifteenth aspect, in the step of performing quality determination, the quality of the beam expander is determined to be good when a moving amount of the position of the laser light detected by the position sensitive detectors is equal to or less than a reference value, or the position of the laser light linearly changes in accordance with change in magnification of the beam expander.

A device for adjusting an optical axis of laser light according to a seventeenth aspect of the present invention includes: a beam expander arranged retractably on an optical path of laser light output from a laser light source toward a workpiece; position sensitive detectors arranged on an upstream side and a downstream side of the beam expander; and an adjustment mechanism configured to move the beam expander to adjust an optical axis of the laser light based on a position of the laser light detected by the position sensitive detectors in a state where the beam expander is arranged on the optical path of the laser light and a position of the laser light detected by the position sensitive detectors in a state where the beam expander is retracted from the optical path of the laser light.

A quality determination method of a beam expander according to an eighteenth aspect of the present invention includes: a step of detecting a position of laser light that is output from a laser light source toward a workpiece, by using position sensitive detectors arranged on an upstream side and a downstream side of a beam expander; and a step of performing good or bad determination for the beam expander based on change in the irradiation position of the laser light detected by the position sensitive detectors when magnification of the beam expander is varied in a state where the beam expander is arranged on an optical path of the laser light.

According to a nineteenth aspect of the present invention, in the quality determination method of a beam expander according to the eighteenth aspect, in the step of performing quality determination, the quality of the beam expander is determined to be good when a moving amount of the position of the laser light detected by the position sensitive detectors is equal to or less than a reference value, or the irradiation position of the laser light linearly changes in accordance with change in magnification of the beam expander.

According to the present invention, an optical axis position of laser light L1 is detected at two or more detection positions, thereby limiting the optical axis of the laser light L1 to one. Hence, it becomes possible to accurately grasp change in the state of the laser light and maintain the quality of laser processing.

### BRIEF DESCRIPTION OF THE DRAWINGS

FIG. 1 is a diagram for describing a method and a device for adjusting an optical axis of laser light according to a first embodiment of the present invention.

FIG. 2 is a block diagram illustrating a laser processing apparatus according to the first embodiment of the present invention.

FIG. 3 is a block diagram illustrating an example of an illumination optical system.

FIG. 4 is a diagram for describing a determination condition to determine whether or not to carry out correcting operation of an optical axis of laser light.

FIG. 5 is a diagram for describing a correcting direction of the optical axis of the laser light.

FIG. 6 is a diagram illustrating the result of optical axis adjustment.

FIGS. 7A and 7B are graphs illustrating the result of optical axis adjustment in a rolling direction.

FIG. 8 is a graph illustrating influence on a beam profile at a processing point when the position of incidence on an optical element is deviated.

FIG. 9 is a flowchart (example 1) showing a method for correcting an optical axis according to the first embodiment of the present invention.

FIG. 10 is a flowchart (example 2) showing the method for correcting an optical axis according to the first embodiment of the present invention.

FIG. 11 is a flowchart showing a method for adjusting an optical axis according to a second embodiment.

FIG. 12 is a flowchart showing the method for adjusting an optical axis according to the second embodiment.

FIGS. 13A and 13B are diagrams respectively illustrating detection results of the laser light before and after adjusting the position of a beam expander.

FIG. 14 is a flowchart showing a first example of a quality determination method of the beam expander.

FIG. 15 is a flowchart showing a second example of the quality determination method of the beam expander.

FIG. 16 is a block diagram illustrating an example of the illumination optical system in a fourth embodiment of the present invention.

FIG. 17 is a diagram illustrating an example of detecting the position of the laser light at one detection position.

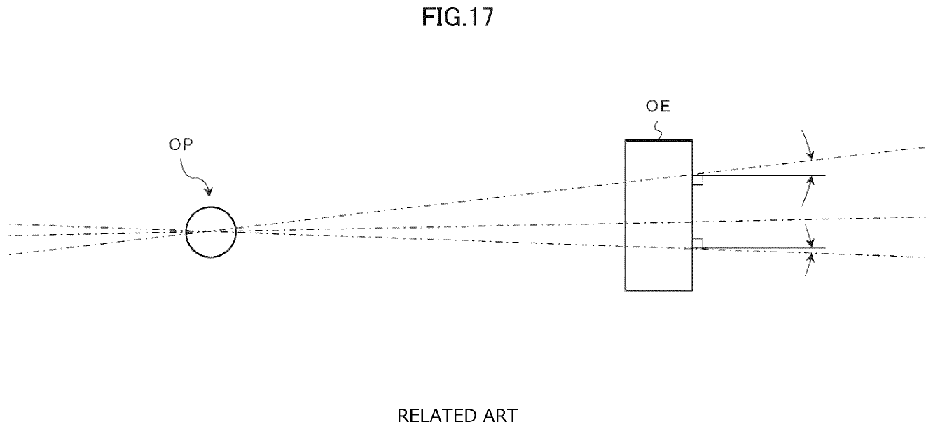

### DESCRIPTION OF THE EMBODIMENTS

Hereinafter, embodiments of a method and a device for adjusting an optical axis of laser light according to the present invention are described based on the accompanying drawings.

### First Embodiment

### (Outline of Method and Device for Adjusting Optical Axis of Laser Light)

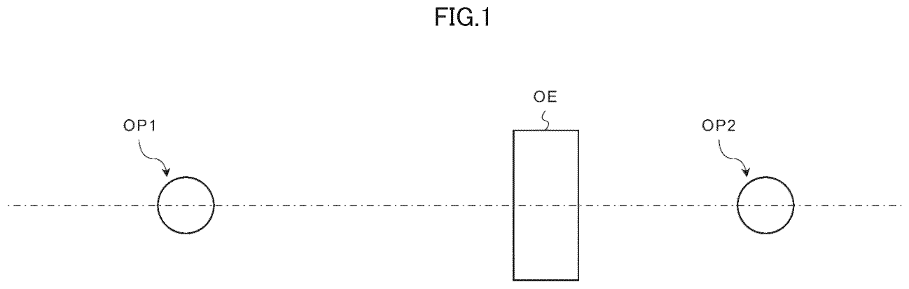

FIG. 1 is a diagram for describing a method and a device for adjusting an optical axis of laser light according to a first embodiment of the present invention.

As illustrated in FIG. 1, a system according to the present embodiment includes a unit that detects laser light (laser beam), which is output from a laser light source of a laser processing apparatus, at two or more detection positions other than a processing point and determines whether or not the position of the optical axis of the laser light is normal. In the example illustrated in FIG. 1, the position of the optical axis of the laser light may be detected in two detection positions OP1 and OP2 which are provided on a downstream side and an upstream side of an optical element OE, respectively.

Further, the system according to the present embodiment includes an adjustment mechanism that adjusts a position or an angle of an optical element holder that holds the optical element OE in accordance with a determination result regarding the position of the optical axis of the laser light. The optical element holder that is adjustable by the adjustment mechanism may be provided at two or more positions on the optical path of the laser light, for example.

The system according to the present embodiment can limit the optical axis of the laser light to one by detecting the laser light at two or more detection positions. As a result, the incident position and incident angle of the laser light which is incident on the optical element OE may be appropriately adjusted. For example, a reflection angle of a mirror may be appropriately adjusted.

Here, in the example shown in FIG. 1, the detection positions (OP1 and OP2) are two or more positions other than the processing point, though the present invention is not limited to this configuration. For example, two or more detection positions (OP1 and OP2) may include a processing point that is a position (irradiation position) to be irradiated with the laser light, on a workpiece.

### (Laser Processing Apparatus)

Hereinafter, a method and a device for adjusting an optical axis of laser light according to the present embodiment are described in detail.

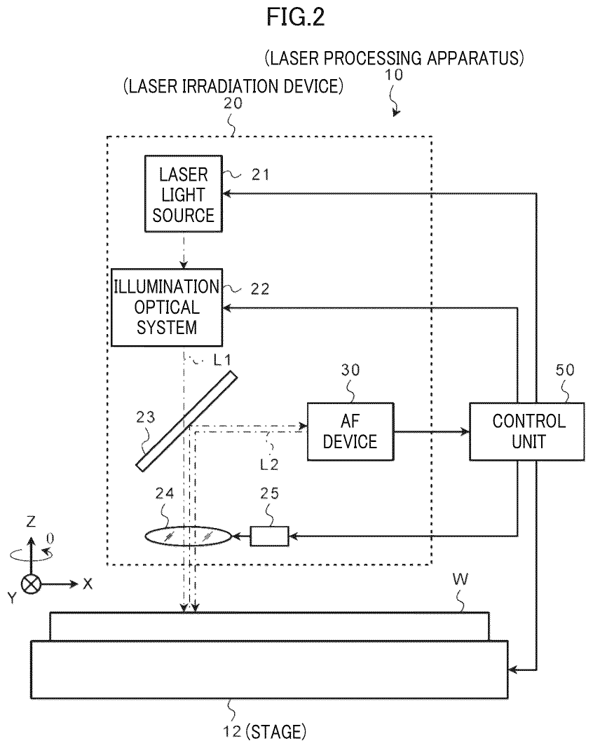

First, an example of the laser processing apparatus is described with reference to FIG. 2. FIG. 2 is a block diagram illustrating the laser processing apparatus according to the first embodiment of the present invention.

As illustrated in FIG. 2, a laser processing apparatus 10 includes a stage 12 that moves a workpiece W (for example, a semiconductor wafer), a laser irradiation device 20 that irradiates the workpiece W with laser light, and a control unit 50 that controls each unit of the laser processing apparatus 10.

Hereinafter, description is given by using a three-dimensional orthogonal coordinate system in which the stage 12 is parallel to XY directions and perpendicular to a Z direction.

The stage 12 is configured to be movable in X, Y, Z and 0 directions. The stage 12 sucks and holds the workpiece W. A back grinding tape (hereinafter referred to as a BG tape) having adhesives is stuck on a front surface on which devices are formed, of the workpiece W. The workpiece W is mounted on the stage 12 with its back surface facing upward in the drawing. Hereinafter, the surface of the workpiece W on the side of a condenser lens 24 is referred to as a laser light irradiation surface.

Here, the laser light irradiation surface may be the surface (back surface) opposite to the surface on the side of the condenser lens 24, of the workpiece W. The workpiece W may have a dicing sheet having adhesives stuck on one surface and may be mounted on the stage 12 in the state of being integrated with a frame through the dicing sheet.

The laser irradiation device 20, which is arranged at a position facing the workpiece W, irradiates the workpiece W with processing laser light L1 to form laser-modified regions in the workpiece W (for example, inside of the workpiece W, etc.).

The control unit 50 includes a central processing unit (CPU), a memory, a storage device, input/output circuits and the like to perform such operation as storing data that is necessary for operating each unit of the laser processing apparatus 10 or for processing.

In addition, the laser processing apparatus 10 includes wafer transfer means, an operation panel, a monitor, an indicator light and the like, which are not illustrated.

The operation panel is equipped with switches and display devices for operating motion of each unit of the laser processing apparatus 10. A TV monitor displays wafer images captured by a CCD (charge coupled device) camera, which is not illustrated, or displays program contents and various kinds of messages. The indicator light indicates an operating status of the laser processing apparatus 10, such as during processing, processing completed, or emergency stop.

Detailed configuration of the laser irradiation device 20 is described next. As illustrated in FIG. 2, the laser irradiation device 20 includes a laser light source 21, an illumination optical system 22, a dichroic mirror 23, the condenser lens 24, an actuator 25, and an AF device 30.

The laser light source 21 emits the processing laser light (hereinafter also referred to as laser light) L1 for forming laser-modified regions inside the workpiece W. For example, the laser light source 21 emits laser light with a pulse width of 1 μs or less and a peak power density of 1×10⁸ (W/cm²) or more at a focus point.

The illumination optical system 22, the dichroic mirror 23 and the condenser lens 24 are arranged on a first optical path of the processing laser light L1 in this order from the side of the laser light source 21. The dichroic mirror 23 allows the processing laser light L1 to pass through and reflects AF laser light L2 emitted from the AF device 30. Note that a second optical path of the AF laser light L2 is bent by the dichroic mirror 23 so as to share part of the optical path with the first optical path of the processing laser light L1, and the condenser lens 24 is arranged on the shared optical path.

The processing laser light L1 emitted from the laser light source 21 passes through the illumination optical system 22 and the dichroic mirror 23 and is then caused to focus on the workpiece W by the condenser lens 24. The condenser lens 24 is finely moved by the actuator 25 in the Z direction so as to adjust a Z-direction position (position in a wafer thickness-direction) of a focus point of the processing laser light L1.

When receiving reflected light of the AF laser light L2 that is emitted to the workpiece W, the AF device 30 outputs information (distance information) about the distance between the condenser lens 24 and the laser light irradiation surface of the workpiece W to the control unit 50.

The control unit 50 controls driving of the actuator 25 so as to maintain a prescribed relation in the distance between the condenser lens 24 and the laser light irradiation surface of the workpiece W (so as to keep a constant distance).

### (Illumination Optical System)

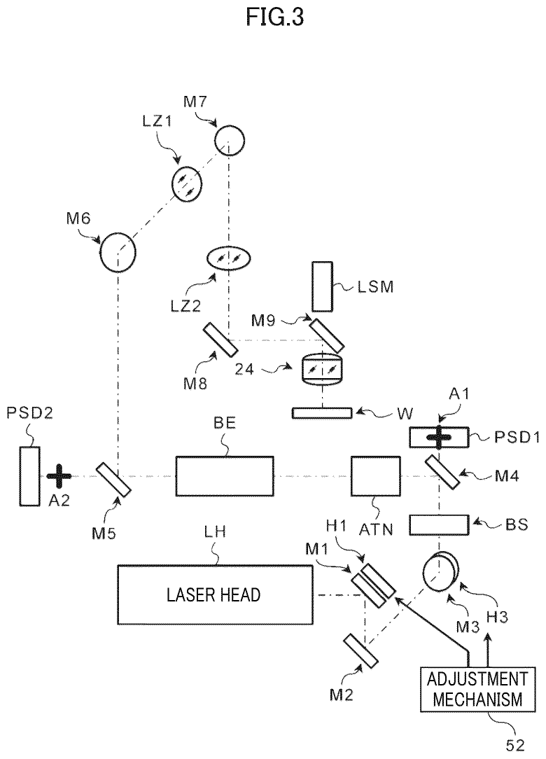

An example of the illumination optical system 22 is described with reference to FIG. 3 next. FIG. 3 is a block diagram illustrating an example of the illumination optical system.

FIG. 3 indicates the optical path of the laser light L1 from a laser head LH of the laser light source 21 to the workpiece W. Note that the dichroic mirror 23 is omitted in FIG. 3.

The laser head LH includes a condenser lens that collects the laser light L1 output from a laser oscillator of the laser light source 21. The laser head LH outputs the condensed laser light L1 to the workpiece W. The laser light L1 is sequentially reflected by mirrors M1 to M3 and a half mirror M4, and is emitted toward an attenuator ATN.

A beam shutter BS controls emission of the laser light L1 to a downstream side (mirror M4 side) in accordance with the control of the control unit 50.

The mirrors M1 and M3 (an example of a pair of movable mirrors) are held by holders H1 and H3, respectively. The holders H1 and H3 are attached to, for example, gimbaled mounts. The mirrors M1 and M3 are steering mirrors having an adjustment mechanism 52 (such as an actuator, for example). The adjustment mechanism 52 rotates the holders H1 and H3 around their respective rotation axes in accordance with the control of the control unit 50, to adjust an incident position and an incident angle of the laser light L1.

After the laser light L1 is attenuated to an appropriate level (amplitude) by the attenuator ATN, a beam diameter of the laser light L1 is expanded by a beam expander BE and the laser light L1 is formed into collimated light (parallel light). Then, the laser light L1 sequentially passes through optical elements, such as a half mirror M5, a mirror M6, a relay lens LZ1, a mirror M7, a relay lens LZ2, a mirror M8 and a half mirror M9, and is caused to focus on the workpiece W through the condenser lens 24.

As illustrated in FIG. 3, position sensitive detectors PSD1 and PSD2 (example of a pair of position sensitive detectors) are respectively arranged on the downstream side of the half mirrors M4 and M5 (example of a pair of half mirrors (fixed mirrors)).

The position sensitive detectors PSD1 and PSD2, which include a photodiode, for example, are sensors that use the surface resistance of the photodiode to detect an incident position of the laser light L1. The position sensitive detectors PSD1 and PSD2 each detect the incident position of the laser light L1 that has passed through the half mirrors M4 and M5. In the example illustrated in FIG. 3, the incident positions of the laser light L1 for respective locations are denoted by reference numerals A1 and A2.

The device for adjusting an optical axis of laser light according to the present invention includes the position sensitive detectors PSD1 and PSD2, and the adjustment mechanism 52 for the mirrors M1 and M3.

Here, as the position sensitive detectors PSD1 and PSD2, sensors that detect the incident position of the laser light L1 using an imaging element may be used, for example.

A laser scanning microscope LSM detects an irradiation position of the laser light L1 on the laser light irradiation surface of the workpiece W. For example, the laser scanning microscope LSM detects the irradiation position of the laser light L1 at all times during laser processing through the half mirror M9, thereby monitoring the state of laser processing.

The number and arrangement of the position sensitive detectors PSD1 and PSD2 are not limited to those in FIG. 3. Further, the number and arrangement of the steering mirrors are also not limited to those in FIG. 3. Mirrors other than the mirrors M1 and M3 may be used as the steering mirrors.

Further, in the present embodiment, the optical axis adjustment is performed by adjusting at least two mirrors M1 and M3, though the optical axis adjustment may be performed by adjusting at least one of the position and the angle of optical elements other than mirrors (for example, lenses, prisms, etc.).

### (Example of Optical Axis Correction)

The following describes the procedure for correcting the optical axis of the laser light L1 using the two position sensitive detectors PSD1 and PSD2.

In the present embodiment, positions A1 and A2 of the laser light L1 are detected by using two position sensitive detectors PSD1 and PSD2. Depending on whether the positions A1 and A2 deviate from an allowable range, the holders H1 and H3 that hold the respective mirrors M1 and M3 are driven to correct the optical axis.

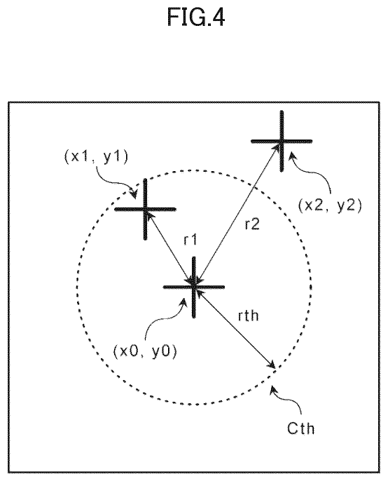

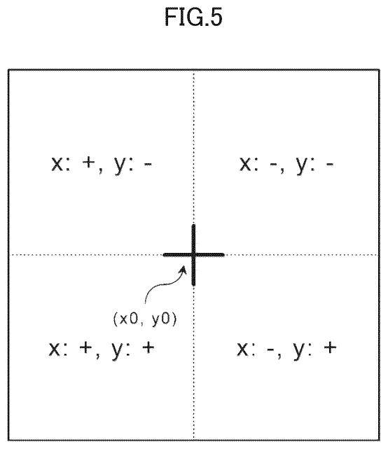

FIG. 4 is a diagram for describing a determination condition to determine whether or not to carry out correcting operation of the optical axis of the laser light, and FIG. 5 is a diagram for describing a correcting direction of the optical axis of the laser light.

In the present embodiment, first, the position sensitive detectors PSD1 and PSD2 are used to detect the irradiation position of the laser light L1 at the time when adjustment of the laser light in the laser irradiation device 20 is completed, and the detected irradiation position of the laser light L1 is used as a reference position (reference value). Further, a threshold value is set for determining optical axis deviation. In the example illustrated in FIG. 4, the reference value is (x0, y0) and the threshold value is rth.

When the laser irradiation device 20 is in use (for example, before and after laser processing, and during laser processing), the position sensitive detectors PSD1 and PSD2 are used to detect the irradiation position of the laser light L1. When a difference r between the position (current value) of the laser light L1 and the reference value exceeds the threshold value rth, the steering mirrors M1 and M3 are driven to adjust optical axis of the laser light L1. The difference r between the current value of the laser light L1 and the reference value is expressed by formula 1 below.

$$r = \sqrt{{( x - x 0 )}^{2} + {( y - y 0 )}^{2}} \qquad [ Formula 1 ]$$

In the example illustrated in FIG. 4, a circle Cth having a radius rth with the reference value (x0, y0) as a center, is shown. When the current values of the laser light L1 detected using the position sensitive detectors PSD1 and PSD2 are both in the circle Cth (case when current value 1 are (x1, y1) and r1<rth), the optical axis adjustment is not executed.

On the contrary, when the current values of the laser light L1 detected using the position sensitive detectors PSD1 and PSD2 are out of the circle Cth (case when current value 2 are (x2, y2) and r2>rth), the optical axis adjustment is executed.

Here, an optical axis adjustment amount (xoff, yoff) may be obtained based on the difference between the current value and the reference value. Specifically, (xoff, yoff)={(x−x0), (y−y0)}.

An adjusting direction (moving direction) of the optical axis is as follows (see FIG. 5).
When xoff<0, the moving direction of the optical axis is toward a positive (+) direction of x direction.
When xoff>0, the moving direction of the optical axis is toward a negative (−) direction of x direction.
When yoff<0, the moving direction of the optical axis is toward a positive (+) direction of y direction.
When yoff>0, the moving direction of the optical axis is toward a negative (−) direction of y direction.

Once the optical axis adjustment is completed, the position sensitive detectors PSD1 and PSD2 may be used to re-detect the irradiation position of the laser light L1 and to confirm the result of the optical axis adjustment. Further, an unillustrated power meter may be used to check laser power (for example, an attenuation amount) on the upstream side of the condenser lens 24 or at the processing point of the workpiece W, and the result of the optical axis adjustment may be confirmed based on the checking result.

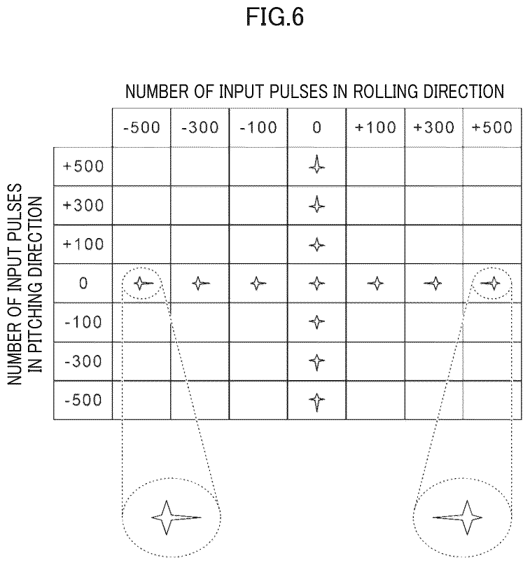

FIG. 6 is a diagram illustrating the result of optical axis adjustment. FIG. 6 illustrates the detection result of the laser light L1 by the position sensitive detector PSD1 arrayed in a cross pattern, in a case where the mirror M1 is moved by every 100 pulses in rolling and pitching directions based on the reference position (center image, (rolling direction, pitching direction)=(0, 0)). Here, the rolling direction is the direction around the axis in a travel direction (optical axis direction) of the laser light L1 and the pitching direction is the direction around the axis in a direction perpendicular to the travel direction. In FIG. 6, the units of the moving amount of the mirrors M1 and M3 (steering mirrors) are expressed by pulses. Here, the moving amount by one pulse is roughly 1 μm.

The image in the center of FIG. 6 ((rolling direction, pitching direction)=(0, 0)) is the detection result of the laser light L1 by the position sensitive detector PSD1 when the mirrors M1 and M3 are both at the reference position. In the center image of FIG. 6, a light beam extending in a cross shape from the laser light L1 is roughly equal in an up-down direction and a right-left direction. Note that the shape and number of light beams extending from the laser light L1 may vary depending on the composition of the optical element included in the illumination optical system 22.

When the mirror M1 is moved in the rolling direction relatively to the reference position, the more the mirror M1 is moved toward the positive (+) side, the more the cross-shaped light beam is offset to the right in the drawing, and the more the mirror M1 is moved toward the negative (−) side, the more the cross-shaped light beam is offset to the left in the drawing, as illustrated in a partially magnified style in FIG. 6.

In the present embodiment, in a case where a deviation from the reference position is detected, the control unit 50 first drives the mirror M1 so that the detection result of the laser light L1 by the position sensitive detector PSD1 becomes equal to the reference position. Next, the control unit 50 drives the mirror M3 so that the detection result of the laser light L1 by the position sensitive detector PSD2 becomes equal to the reference position. After that, driving of the mirrors M1 and M3 is repeated in sequence to converge the position of the laser light L1 at the reference position.

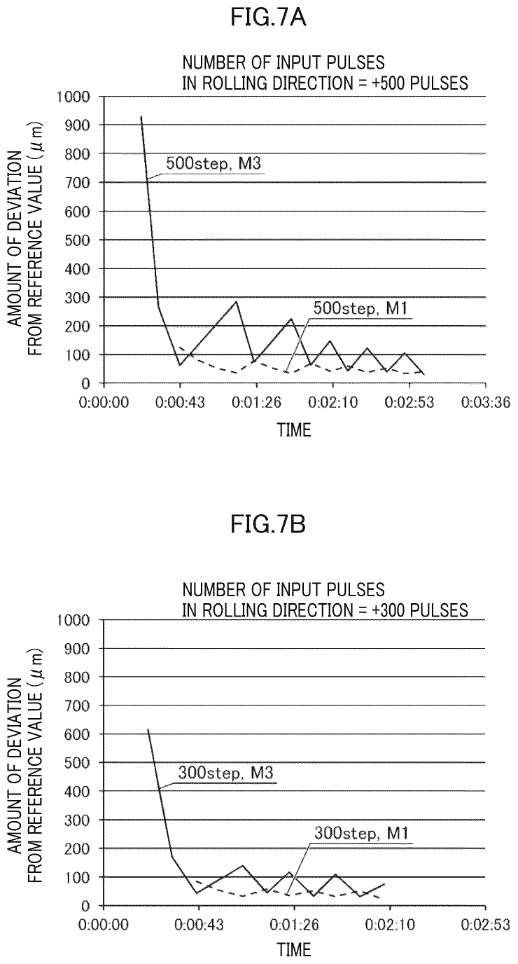

FIGS. 7A and 7B are graphs illustrating the result of optical axis adjustment in the rolling direction. FIG. 7A shows the result of optical axis adjustment when the mirror M1 is moved by +500 pulses in the rolling direction, and FIG. 7B shows the result of optical axis adjustment when the mirror M1 is moved by +300 pulses in the rolling direction. Each graph shows the change in the deviation amounts (amounts of deviation) of the mirrors M1 and M3 (μm) from the reference position over time when the mirrors M1 and M3 are repeatedly driven.

As shown in FIGS. 7A and 7B, it is understood that the deviation amounts from the reference position converge due to repeated driving of the mirrors M1 and M3 in both the cases where the moving amount of the mirror M1 is +500 pulses and +300 pulses. This indicates that when the moving amount from the reference position (that is, the sum of an assumed positional change amount (deviation amount) of the mirror (M1 or M3) and a margin) is about 500 μm, the correcting operation is feasible by the optical axis adjustment. Note that similar correction may also be performed in the pitching direction and a yawing direction.

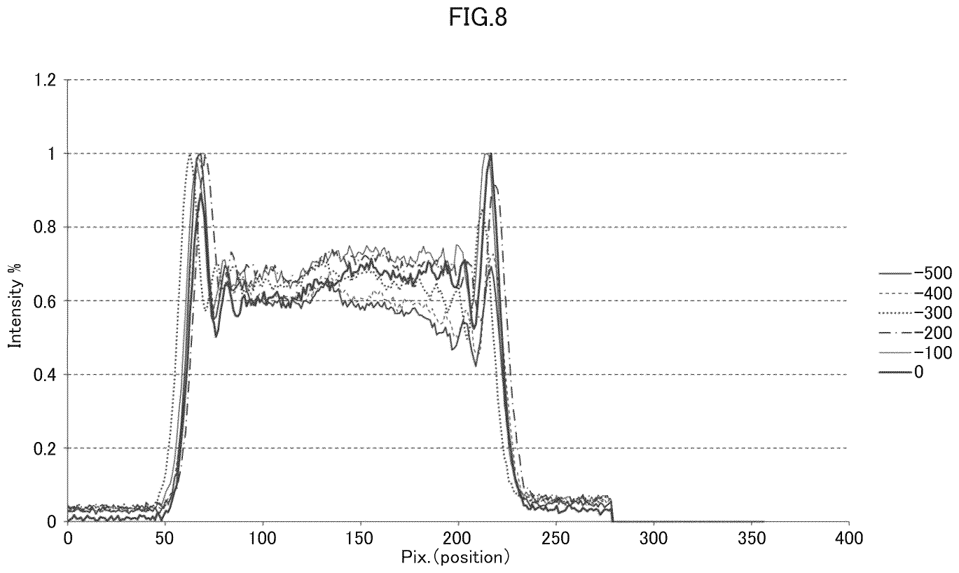

FIG. 8 is a graph illustrating influence on a beam profile at the processing point when the incident position on an optical element is deviated. FIG. 8 shows the beam profile at the processing point when the deviation amount from the reference position is 0 to 500 μm. A horizontal axis of FIG. 8 represents the pixels of an imaging element of the laser scanning microscope LSM, and a vertical axis represents the intensity of the laser light L1.

It is understood, from the example shown in FIG. 8, that the shape of a beam profile graph at the processing point fluctuates with the change in the deviation amount from the reference position.

The present embodiment may restrain the fluctuation in the beam profile as illustrated in FIG. 8 by detecting the position of the laser light L1 at two or more positions on the optical path of the laser light L1 and driving the mirrors M1 and M3 to reduce (eliminate) the deviation amount from the reference position.

### (Method for Correcting Optical Axis (Example 1))

A method for correcting optical axis according to the present embodiment is described next.

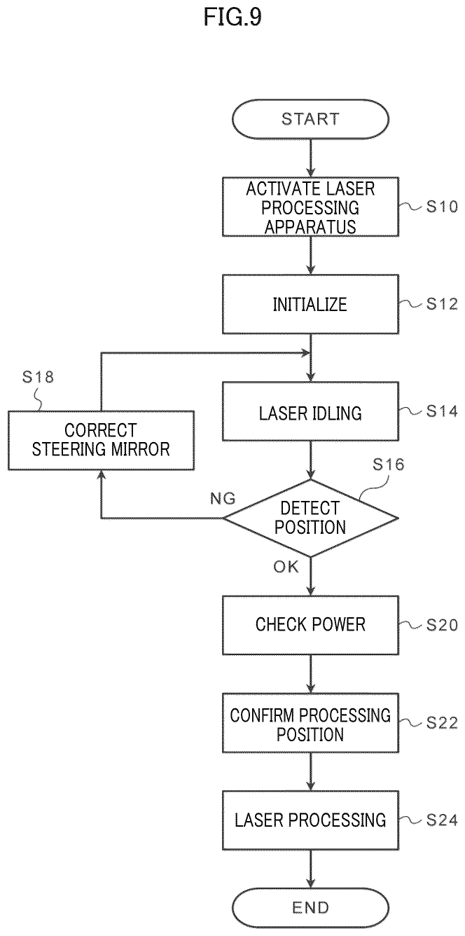

FIG. 9 is a flowchart (example 1) showing the method for correcting an optical axis according to the first embodiment of the present invention. FIG. 9 shows an example in which the optical axis adjustment is performed at the start-up of the system of the laser processing apparatus 10 or performed manually.

First, when the laser processing apparatus 10 is activated (step S10) and initialized (step S12), a laser idling state is asserted (step S14). Here, the laser idling state is the state in which the laser light L1 is being output toward a processing point on the workpiece W.

Next, the irradiation position of the laser light L1 is detected using the position sensitive detectors PSD1 and PSD2 (step S16) and the directions of the mirrors M1 and M3 (steering mirrors) are corrected (step S18). Then, as illustrated in FIG. 4, correction of the directions of the mirrors M1 and M3 is repeated until the irradiation position (current value) of the laser light L1 matches the reference value, or the difference r from the reference value becomes equal to or less than the threshold value rth.

Here, the threshold value during the optical axis adjustment (step S16) at the start-up of the system may be smaller than the threshold value rth at the time of determining the necessity of the optical axis adjustment in FIG. 4.

Then, when the correction of the direction of the mirrors M1 and M3 is ended (steps S14 to S18), laser power on the upstream side of the condenser lens 24 or at the processing point of the workpiece W is confirmed by a power meter (step S20) and the irradiation position (processing point) of the laser light L1 is confirmed by the laser scanning microscope LSM (step S22), and then laser processing is performed (step S24)

### (Method for Correcting Optical Axis (Example 2))

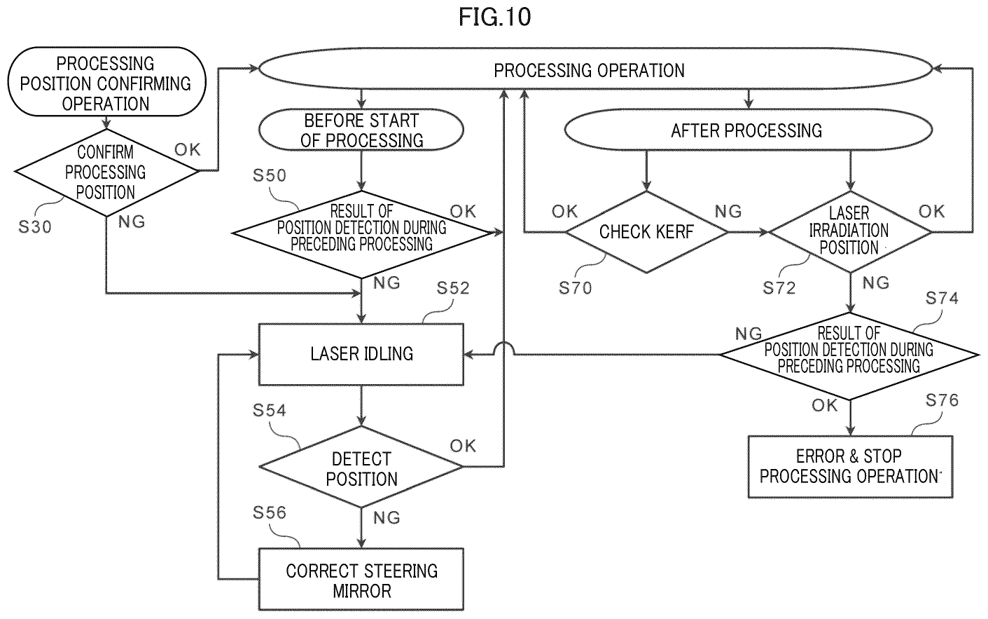

FIG. 10 is a flowchart (example 2) showing the method for correcting an optical axis according to the first embodiment of the present invention. FIG. 10 shows a case where the optical axis adjustment is performed during execution of laser processing by the laser processing apparatus 10.

First, when the laser processing is executed, processing position confirming operation is performed prior to the processing operation. In a case of performing the processing position confirmation (step S30), as illustrated in FIG. 4, OK is determined when the difference r between the irradiation position (current value) of the laser light L1 and the reference value is equal to or less than the threshold value rth, and NG is determined when the difference r exceeds the threshold value rth. Then, when OK is determined in step S30, the flow shifts to the processing operation without execution of the optical axis adjustment. On the contrary, when NG is determined in step S30, the optical axis adjustment is executed (steps S52 to S56).

In the optical axis adjustment, first, a laser idling state is asserted (step S52), the irradiation position of the laser light L1 is detected using the position sensitive detectors PSD1 and PSD2 (step S54), and the direction of the mirrors M1 and M3 (steering mirrors) is corrected (step S56). Then, the correction of the direction of the mirrors M1 and M3 is repeated until the irradiation position (current value) of the laser light L1 matches the reference value or the difference r from the reference value becomes equal to or less than the threshold value rth. Note that the threshold value at the time of the optical axis adjustment in step S54 may be less than the threshold value rth at the time of determining the necessity of optical axis adjustment in step S30 and step S50 described later.

Next, when the correction of the direction of the mirrors M1 and M3 is ended (steps S52 to S56), the flow shifts to the processing operation. Before the processing operation, a power check and a check of the irradiation position (processing point) of the laser light L1 may be performed.

The optical axis adjustment before the start of the processing operation is described next. In this case, the irradiation position of the laser light L1, which is detected by the position sensitive detectors PSD1 and PSD2, during execution of the preceding processing operation is acquired (step S50) and the necessity of the optical axis adjustment is determined in the same way as in step S30. Then, when OK is determined in step S50, the flow shifts to the processing operation without execution of the optical axis adjustment. On the contrary, when NG is determined in step S50, the optical axis adjustment is executed (steps S52 to S56).

Description is now given of the operation that is performed after the end of the processing operation, for example, after the processing operation for a specified number of scheduled dividing lines is ended and before processing operation for next scheduled dividing lines is started. After the end of the processing operation, firstly, a kerf inspection (kerf check) for kerf formed by laser processing (step S70) and a check of irradiation position of the laser light L1 (step S72) are performed by the laser scanning microscope LSM.

When OK is determined in both the steps S70 and S72, the flow shifts to the next processing operation, and when NG is determined in both the steps S70 and S72, the irradiation position of the laser light L1, which is detected by the position sensitive detectors PSD1 and PSD2, during execution of the preceding processing operation is acquired (step S74) and the necessity of the optical axis adjustment is determined in the same way as in step S50. Note that only one of steps S70 and S72 may be performed.

Next, when NG is determined in step S74, the optical axis adjustment is executed (steps S52 to S56). On the contrary, when OK is determined in step S74, countermeasures other than the optical axis adjustment is needed for the kerf inspection error and a detection position error of the laser scanning microscope LSM. Therefore, an error message is output and the processing operation is stopped without execution of the optical axis adjustment (step S76).

According to the present embodiment, since the optical axis position of the laser light L1 is detected at two or more detection positions, the optical axis of the laser light L1 may be limited to one. This makes it possible to cause, for example, the laser light L1 to enter the optical element perpendicularly or to limit the reflection angle on the mirror to 45°. Further, the present embodiment may restrain, for example, fluctuation in the positional relationship between the optical element and the laser beam to 50 μm or less, so that the quality of the laser processing may be automatically maintained without the intervention of an engineer.

Further, there may be a case where pointing stability of the laser head LH deteriorates due to change in temperature of the external environment, resulting in deviation of the irradiation position of the laser light L1. Even when the irradiation position of the laser light L1 incident onto the beam expander BE has changed, the optical axis adjustment according to the present embodiment may correct the deviation of the irradiation position of the laser light L1.

### Second Embodiment

Although the optical axis adjustment is performed in accordance with the position of the laser light L1 detected using the position sensitive detectors PSD1 and PSD2 in the above embodiment, the deviation of the beam expander BE may also affect the beam profile at the processing point and may affect the quality of the laser processing. Therefore, in addition to or instead of the above embodiment, the optical axis adjustment may also be performed for the beam expander BE.

In a second embodiment, the beam expander BE is configured so as to be retractable (emerge on and retract) from the optical path of the laser light L1. The retracting operation of the beam expander BE may be performed manually or performed automatically by an actuator controllable by the control unit 50.

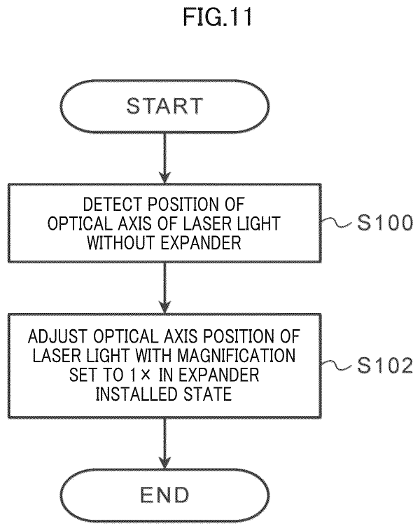

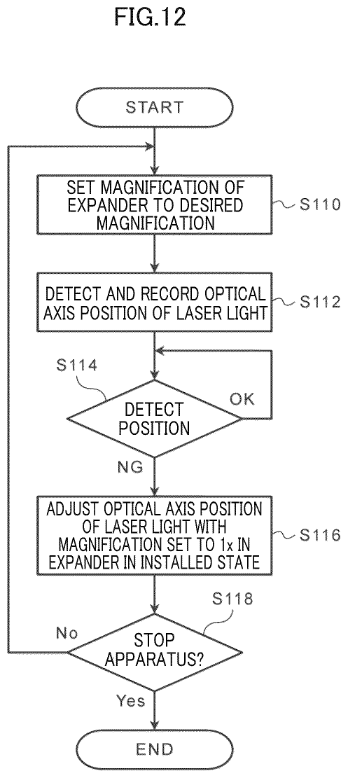

FIGS. 11 and 12 are flowcharts showing a method for adjusting an optical axis according to the second embodiment. Note that in the following description, component members similar to those in the above embodiment are designated by identical reference numerals to omit description.

First, the optical axis adjustment (pre-adjustment) before the start of laser processing is described with reference to FIG. 11.

In a case of performing the pre-adjustment, the position of the laser light L1 is first detected using the position sensitive detectors PSD1 and PSD2 while the beam expander BE is retracted from the optical path of the laser light L1 (step S100).

Next, the beam expander BE is moved onto the optical path of the laser light L1 and the magnification of the beam expander BE is set to 1× (one). Then, the position of the laser light L1 in the state where the beam expander BE is moved onto the optical path of the laser light L1 is matched with the position of the laser light L1 in the state where the beam expander BE is retracted from the optical path of the laser light L1 to perform optical axis adjustment (step S102).

Here, in step S102, it is not necessary to completely match the position of the laser light L1 in the state where the beam expander BE is moved onto the optical path of the laser light L1 with the position of the laser light L1 in the state where the beam expander BE is retracted from the optical path of the laser light L1. For example, a difference between the position of the laser light L1 in the state where the beam expander BE is moved onto the optical path of the laser light L1 and the position of the laser light L1 in the state where the beam expander BE is retracted from the optical path of the laser light L1 may be equal to or less than a prescribed threshold.

The optical axis adjustment after the start (during execution) of the laser processing is described next with reference to FIG. 12.

First, the magnification of the beam expander BE is set to the magnification required for laser processing (step S110), and the position of the laser light L1 is detected and recorded using the position sensitive detectors PSD1 and PSD2 (step S112).

Then, during laser processing, the position of the laser light L1 is detected using the position sensitive detectors PSD1 and PSD2 (step S114). In step S114, as in FIG. 4, OK is determined when the difference r between the irradiation position (current value) of the laser light L1 and the reference value is equal to or less than the threshold value rth, and NG is determined when the difference r exceeds the threshold value rth. Then, when OK is determined in step S114, the processing operation is continued without execution of the optical axis adjustment. On the contrary, when NG is determined in step S114, the optical axis adjustment is executed (step S116).

In step S116, as in step S102, the position of the laser light L1 in the state where the magnification of the beam expander BE is set to 1× (one) and the beam expander BE is moved onto the optical path of the laser light L1 is matched with the position of the laser light L1 in the state where the beam expander BE is retracted from the optical path of the laser light L1, thereby performing optical axis adjustment.

Then, once the optical axis adjustment (step S116) is completed, the magnification of the beam expander BE is set to the magnification required for laser processing (step S110), the position of the laser light L1 is detected and recorded using the position sensitive detectors PSD1 and PSD2, and then laser processing is continued. Then, the laser processing is ended (step S118), the apparatus is stopped.

Here, in the present embodiment, a kerf inspection error and a check of the detection position of the laser scanning microscope LSM may be performed after step S118, in the same way as in the example shown in FIG. 10.

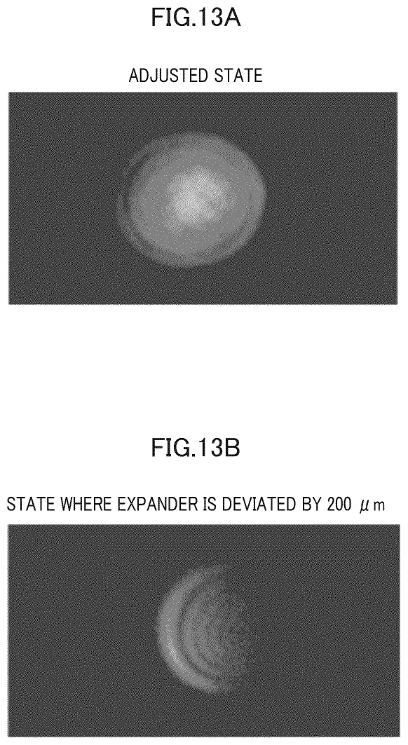

FIGS. 13A and 13B are diagrams illustrating detection results of the laser light L1 before and after adjustment of the position of the beam expander. In FIGS. 13A and 13B, the lighter the color, the higher the intensity of the laser light L1.

When the beam expander BE is deviated by 200 μm, the beam profile of the laser light L1 is distorted (biased) as shown in FIG. 13B. In contrast, when the position of the beam expander BE is moved in the adjustment direction and the laser light L1 is adjusted to the reference position, the beam profile becomes a roughly circular shape in which the laser light L1 is uniformly distributed in the rolling and pitching directions as shown in FIG. 13A.

The present embodiment enables to maintain the quality of the beam profile of the laser light L1, so that the quality of the laser processing may be automatically maintained without the intervention of an engineer.

### Modifications

Although in the present embodiment, the magnification of the beam expander BE is set to 1× (one) during optical axis adjustment (steps S102 and S116), the present invention is not limited to this. At the time of adjusting the optical axis, the magnification of the beam expander BE may be set to the magnification other than 1×. Further, both the optical axis adjustment by setting the magnification of the beam expander BE to 1× and the optical axis adjustment by setting the magnification of the beam expander BE to magnification other than 1× may be performed.

When the magnification of the beam expander BE is set to 1×, the beam expander BE may be considered as an optical equivalence of a transparent plate. In this case, a difference (deviation amount) between the position of the laser light L1 in the state where the beam expander BE is moved onto the optical path of the laser light L1 and the position of the laser light L1 in the state where the beam expander BE is retracted from the optical path of the laser light L1 may be evaluated as a result of inclination (tilt) of the beam expander BE with respect to the optical axis of the laser light L1.

In the second embodiment, the position of the laser light L1 in the state where the beam expander BE is moved onto the optical path of the laser light L1 is matched with the position of the laser light L1 in the state where the beam expander BE is retracted from the optical path of the laser light L1 to make the deviation amount roughly equal to zero (see steps S102 and S116). This makes it possible to adjust the tilt of the beam expander BE with respect to the optical axis of the laser light L1 and to make the optical axis of the beam expander BE to be parallel to the optical axis of the laser light L1.

When the magnification of the beam expander BE is set to the magnification other than 1×, a beam diameter of the laser light L1 is expanded according to the magnification setting. In this case, a difference (deviation amount) between the position of the laser light L1 in the state where the beam expander BE is moved onto the optical path of the laser light L1 and the position of the laser light L1 in the state where the beam expander BE is retracted from the optical path of the laser light L1 may be evaluated as a result of a parallel deviation. Here, the parallel deviation is the deviation of the optical axis of the beam expander BE with respect to the optical axis of the laser light L1 and appears as deviation in the incident position on a plane perpendicular to the optical axis of the laser light L1.

In this case also, the position of the laser light L1 in the state where the beam expander BE is moved onto the optical path of the laser light L1 is matched with the position of the laser light L1 in the state where the beam expander BE is retracted from the optical path of the laser light L1 to make the deviation amount roughly equal to zero (see steps S102 and S116). This makes it possible to adjust the parallel deviation of the beam expander BE with respect to the optical axis of the laser light L1.

As described above, the tilt and the parallel deviation of the beam expander BE may be adjusted by varying the magnification in the state in which the beam expander BE is inserted.

Note that when the magnification of the beam expander BE is set to 1×, optical axis adjustment may be performed by rotating the beam expander BE with respect to the optical axis of the laser light L1. In contrast, when the magnification of the beam expander BE is set to the magnification other than 1×, an adjustment axis of the beam expander BE is limited to the parallel direction. Specifically, while keeping the inclination of the beam expander BE with respect to the optical axis of the laser light L1, the beam expander BE may be moved so as to adjust the optical axis. In other words, it is possible to limit the axis to be adjusted for optical axis adjustment depending on whether the magnification of the beam expander BE is 1× or other than 1×.

### Third Embodiment

In each of the above embodiments, explanation is given for the cases where the beam expander BE is normal. However, there may also be cases where the beam expander BE is abnormal. Here, the beam expander BE being abnormal includes, for example, a case where the lenses included in the beam expander BE are not coaxial with each other and a case where inclinations of lens are different.

Consider a case where the magnification of the beam expander BE is sequentially varied to 1×, 1.2×, 1.4×, 1.6×, . . . , 4×, and so on, and the coordinates of the irradiation position of the laser light L1 are plotted for each magnification. When the beam expander BE is normal and the optical axis adjustment is appropriately performed, the coordinates of the irradiation position of the laser light L1 do not move. On the contrary, when the beam expander BE is normal though there is a tilt or a parallel deviation (deviation of incident position) or there are both the tilt and the parallel deviation (such as a case where optical axis adjustment is not performed), the coordinates of the irradiation position of the laser light L1 move linearly.

In contrast, when the beam expander BE is abnormal, the coordinates of the irradiation position of the laser light L1 show movement (for example, non-linear movement or the like) different from the movement when the beam expander BE is normal.

In the present embodiment, it is determined whether the quality of the beam expander BE is good or bad using the above characteristics. Note that the quality determination of the beam expander BE may be performed regardless of whether the optical axis adjustment described above is carried out or not.

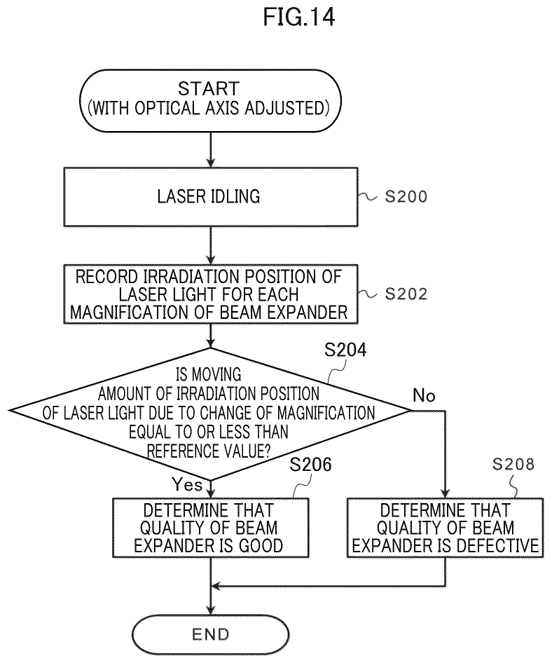

FIG. 14 is a flowchart showing a first example of the quality determination method of the beam expander. FIG. 14 shows the quality determination method in a case where the optical axis adjustment of the beam expander BE has been carried out.

First, when the laser processing apparatus 10 is activated and initialized, a laser idling state is asserted (step S200). Then, the magnification of the beam expander BE is changed, and the irradiation position of the laser light L1 at each magnification is detected and recorded (step S202).

Next, it is determined whether the moving amount of the irradiation position of the laser light L1 due to the change in the magnification of the beam expander BE is equal to or less than the reference value (step S204). Here, the reference value in step S204 is, for example, a positive value close to zero.

When the moving amount of the irradiation position of the laser light L1 due to the change in the magnification of the beam expander BE is equal to or less than the reference value (Yes in step S204), the quality of the beam expander BE is determined to be good (step S206).

When the moving amount of the irradiation position of the laser light L1 due to the change in the magnification of the beam expander BE exceeds the reference value (No in step S204), the quality of the beam expander BE is determined to be defective (step S208).

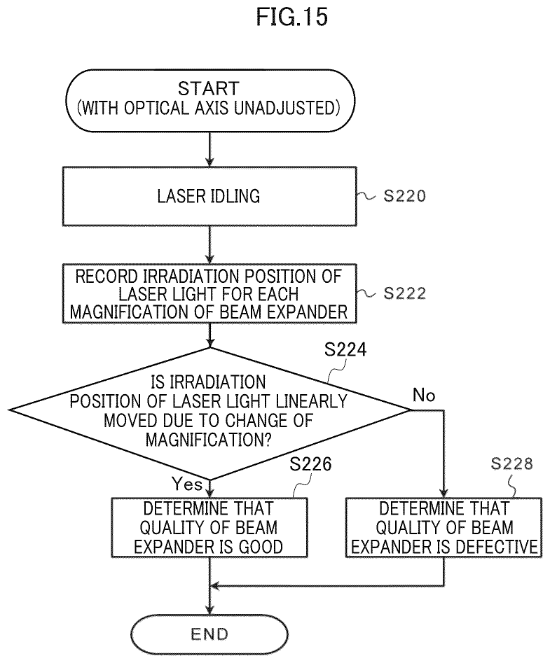

FIG. 15 is a flowchart showing a second example of the quality determination method of the beam expander. FIG. 15 shows the quality determination method when the optical axis adjustment of the beam expander BE is not carried out.

First, when the laser processing apparatus 10 is activated and initialized, the laser idling state is asserted (step S220). Then, the magnification of the beam expander BE is changed, and the irradiation position of the laser light L1 at each magnification is detected and recorded (step S222).

Next, it is determined whether or not the irradiation position of the laser light L1 moves linearly due to the change in the magnification of the beam expander BE (step S224). In step S224, it is possible to evaluate whether the irradiation position of the laser light L1 moves linearly depending on, for example, whether a correlation coefficient when the irradiation position of the laser light L1 at each magnification is plotted is close to 1 or not.

When it is determined that the irradiation position of the laser light L1 moves linearly due to the change in the magnification of the beam expander BE (Yes in step S224), the quality of the beam expander BE is determined to be good (step S226).

When it is determined that the irradiation position of the laser light L1 does not move linearly due to the change in the magnification of the beam expander BE (No in step S224), the quality of the beam expander BE is determined to be defective (step S226).

In the present embodiment, the quality determination of the beam expander BE may be performed, for example, before and after the optical axis adjustment. For example, the quality determination of the beam expander BE may be performed before the optical axis adjustment, so that the beam expander BE may be adjusted or replaced. This makes it possible to enhance the accuracy of the optical axis adjustment with the beam expander BE.

Note that the timing to carry out the quality determination for the beam expander BE is not particularly limited. The quality determination for the beam expander BE may also be carried out in such timing as, for example, at the start-up of the system and during execution of laser processing.

### Fourth Embodiment

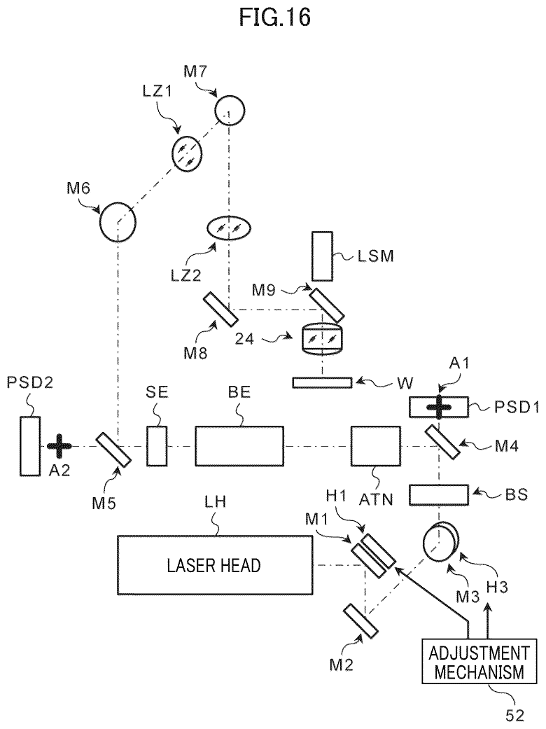

FIG. 16 is a block diagram illustrating an example of an illumination optical system in a fourth embodiment of the present invention. FIG. 16 illustrates an example in which an optical element for laser light shaping SE is arranged between the beam expander BE and the half mirror M5.

The optical element for laser light shaping SE is an optical element for adjusting the state of the laser light L1 from the beam expander BE. Specifically, the optical element for laser light shaping SE performs shaping of the laser light L1 from the beam expander BE in accordance with the content of the laser processing in the laser processing apparatus 10. Here, the content of laser processing includes, for example, grooving with laser ablation, scribing, cutting or drilling processing, or formation of laser-modified regions serving as starting points of cutting (cracking) of the workpiece W.

The optical element for laser light shaping SE includes, for example, a refractive optical element (ROE), a cylindrical lens or a mask. The ROE is a refractive optical element that shapes the beam shape of the laser light L1 into a desired shape (for example, round shapes, ring shapes, line shapes, rectangular shapes, polygonal shapes, etc.). The cylindrical lens which is a lens including a cylindrical part. The cylindrical lens is an optical element for shaping the laser light L1 into a liner beam shape or for expanding or contracting the laser light L1 only in one direction on a plane perpendicular to the optical axis of the laser light L1. The mask is an optical element which blocks part of the laser light L1 so as to shape the beam shape of the laser light L1.

In the present embodiment, since the method for adjusting an optical axis according to each of the embodiments is applied, it becomes possible to enhance the accuracy of the irradiation position when the optical element for laser light shaping SE is irradiated with the laser light L1 from the beam expander BE. As a result, it is possible to stabilize a shaping result of the laser light L1 that is emitted to the optical element for laser light shaping SE.

Although in the example illustrated in FIG. 16, the optical element for laser light shaping SE is arranged between the beam expander BE and the half mirror M5, the present invention is not limited to the example. For example, the optical element for laser light shaping SE may be arranged between the half mirror M5 and the mirror M6 or may be arranged elsewhere (positions downstream of the beam expander BE).

### REFERENCE SIGNS LIST

10 . . . Laser processing apparatus, 12 . . . Stage, 20 . . . Laser irradiation device, 21 . . . Laser light source, 22 . . . Illumination optical system, 23 . . . Dichroic mirror, 24 . . . Condenser lens, 25 . . . Actuator, 30 . . . AF device, 50 . . . Control unit, 52 . . . Adjustment mechanism, H1, H3 . . . Holder, M1 to M3, M6 to M8 . . . Mirror, M4 to M5, M9 . . . Half mirror, PSD1 to PSD2 . . . Position sensitive detector, LH . . . Laser head, ATN . . . Attenuator, BE . . . Beam expander, LZ1, LZ2 . . . Relay lens, LSM . . . Laser scanning microscope, SE . . . Optical element for laser beam shaping

What is claimed is:

1. A method for adjusting an optical axis of laser light, comprising:
a step of detecting a position of laser light that is output from a laser light source toward a workpiece, by using a pair of position sensitive detectors respectively arranged at positions after the laser light has passed through a pair of half mirrors, the pair of half mirrors respectively fixed on an upstream side and a downstream side of a beam expander; and
a step of adjusting, based on the position of the laser light, at least one of a position and an angle of a pair of movable mirrors that is arranged closer to the laser light source than the pair of half mirrors on an optical path of the laser light, to adjust an optical axis of the laser light.

2. The method for adjusting an optical axis of laser light according to claim 1, wherein
the pair of position sensitive detectors is provided at a position other than a processing point to be irradiated with the laser light, on the workpiece.

3. The method for adjusting an optical axis of laser light according to claim 1, wherein
when a difference between the position of the laser light detected by the pair of position sensitive detectors and a preset reference value is equal to or more than a threshold value, adjustment of the optical axis of the laser light is performed.

4. The method for adjusting an optical axis of laser light according to claim 3, wherein
adjusting at least one of the position and the angle of one of the pair of movable mirrors and setting the position of the laser light detected by one of the pair of position sensitive detectors as a reference value, are repeated for each of the movable mirrors to converge the position of the laser light detected by each position sensitive detector with the respective reference position.

5. A device for adjusting an optical axis of laser light, comprising:
a pair of position sensitive detectors respectively arranged at positions after the laser light has passed through a pair of half mirrors, the pair of half mirrors respectively fixed on an upstream side and a downstream side of a beam expander; and
an adjustment mechanism configured to adjust, based on a position of the laser light detected by each of the position sensitive detectors, at least one of a position and an angle of a pair of movable mirrors that is arranged closer to a laser light source than the pair of half mirrors on an optical path of the laser light, to adjust an optical axis of the laser light.

6. A method for adjusting an optical axis of laser light, comprising:
a step of detecting a position of laser light output from a laser light source toward a workpiece, by using position sensitive detectors respectively arranged on an upstream side and a downstream side of a beam expander; and
a step of moving the beam expander to adjust an optical axis of the laser light, based on the position of the laser light detected by the position sensitive detectors in a state where the beam expander is arranged on an optical path of the laser light and the position of the laser light detected by the position sensitive detectors in a state where the beam expander is retracted from the optical path of the laser light.

7. The method for adjusting an optical axis of laser light according to claim 6, wherein
in adjusting the optical axis, the position of the laser light in a state where magnification of the beam expander is set to 1× is adjusted in accordance with the position of the laser light in the state where the beam expander is retracted from the optical path of the laser light.

8. The method for adjusting an optical axis of laser light according to claim 6, wherein
in adjusting the optical axis, the position of the laser light in a state where magnification of the beam expander is set to other than 1× is adjusted in accordance with the position of the laser light in the state where the beam expander is retracted from the optical path of the laser light.

9. The method for adjusting an optical axis of laser light according to claim 6, comprising
a step of performing quality determination for the beam expander based on change in the position of the laser light detected by the position sensitive detectors when the magnification of the beam expander is changed.

10. The method for adjusting an optical axis of laser light according to claim 9, wherein
in the step of performing quality determination, quality of the beam expander is determined to be good when a moving amount of the position of the laser light detected by the position sensitive detectors is equal to or less than a reference value, or the position of the laser light linearly changes in accordance with change in the magnification of the beam expander.

11. A device for adjusting an optical axis of laser light, comprising:
a beam expander arranged retractably on an optical path of laser light output from a laser light source toward a workpiece;
position sensitive detectors arranged on an upstream side and a downstream side of the beam expander; and
an adjustment mechanism configured to move the beam expander to adjust an optical axis of the laser light, based on a position of the laser light detected by the position sensitive detectors in a state where the beam expander is arranged on the optical path of the laser light and a position of the laser light detected by the position sensitive detectors in a state where the beam expander is retracted from the optical path of the laser light.
